(19) United States
(12) Patent Application Publication
(10) Pub. No.: US 2015/0265126 A1
(43) Pub. Date: Sep. 24, 2015

(54) PORTABLE TOILET SANITATION KIT AND METHOD OF USE

(71) Applicants: Gerald Brown, Castroville, CA (US); Rose Brown, Castroville, CA (US)

(72) Inventors: Gerald Brown, Castroville, CA (US); Rose Brown, Castroville, CA (US)

(21) Appl. No.: 14/220,463

(22) Filed: Mar. 20, 2014

(51) Int. Cl. A47L 13/17; B08B 1/00; A47K 13/16

(52) U.S. Cl. CPC A47L 13/17; A47K 13/16; B08B 1/006

(57) ABSTRACT

A portable toilet sanitation kit comprising a carrying container to house a plurality of items, where the carrying container includes a closure; at least one packet with a sanitizing wipe, where the packet is carried within the carrying container; and a toilet seat cover folded within the carrying container, where the toilet seat cover includes a perimeter sheet with a central opening, where the perimeter sheet rests atop a toilet seat, and where the perimeter sheet extends between a back portion and a front portion; and an outer flap hanging at an outer edge of the perimeter sheet at the front portion of the toilet seat.

### BACKGROUND OF THE INVENTION

1. Field of the Invention

The present invention relates to a kit to sanitize and serve as a barrier between a user and a shared toilet.

2. Description of Related Art

Many people are concerned with the variety of germs and bacteria that may be present in public bathroom facilities. Because many people fail to wash their hands after using the restroom the most hesitant areas to come into contact with are also the most used; the door handles and toilet seats. While trying to avoid sitting on the seat many people try squatting over the toilet, suspending their bodies a few inches over the bowl without actually touching the seat. This in and of itself creates a mess if they don't complete their business in the bowl, thereby dirtying the toilet more than it was before they started. The person must clean the toilet after they use it otherwise they leave a soiled toilet for the next person.

To mitigate the amount of direct toilet seat exposure, many people will position a paper liner on the toilet seat before sitting. If a liner is unavailable toilet paper may also be used. A problem sometimes experienced is that after flushing the liner or toilet paper may not all go into the drain forcing the user to use their hand to discard. Also, an embarrassing occurrence is when a piece of the liner or toilet paper gets stuck on the user's body or clothing without their knowledge and they wear the paper out of the restroom.

Because so many people are trying to find a better method of toilet and restroom personal protection, it would be beneficial in the art to provide an all-in-one kit that cleans and provides a barrier between the user and the toilet.

### SUMMARY OF THE INVENTION

In view of the foregoing disadvantages inherent in the prior art, the general purpose of the present invention is to provide a portable toilet sanitation kit, configured to include all of the advantages of the prior art, and to overcome the drawbacks inherent therein.

Accordingly, an object of the present invention is to provide a kit of items to protect a user from the germs and bacteria present in a public restroom.

Another object of the present invention is to provide a portable toilet sanitation kit that includes a sanitary wipe, a reusable toilet seat cover and a bottle of sanitization solution to disinfect a user's hands.

To achieve the above objects, in an aspect of the present invention, a portable toilet sanitation kit is described comprising a carrying container to house a plurality of items, where the carrying container includes a closure; at least one packet with a sanitizing wipe, where the packet is carried within the carrying container; and a toilet seat cover folded within the carrying container, where the toilet seat cover includes a perimeter sheet with a central opening, where the perimeter sheet rests atop a toilet seat, and where the perimeter sheet extends between a back portion and a front portion; and an outer flap hanging at an outer edge of the perimeter sheet at the front portion of the toilet seat.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts an expanded view of a portable toilet sanitation kit in accordance with an exemplary embodiment of the present invention;

FIG. 1(A) depicts an enlarged view of a toilet seat cover in accordance with an exemplary embodiment of the present invention; and

FIG. 2 depicts a perspective view of a portable toilet sanitation kit in accordance with an exemplary embodiment of the present invention.

Like reference numerals refer to like parts throughout the description of several views of the drawings.

### DETAILED DESCRIPTION OF THE DRAWINGS

The present invention relates to a kit to sanitize and serve as a barrier between a user and a shared toilet. The present invention provides a portable toilet sanitation kit to help protect users from becoming contaminated or spreading bacteria while using public restrooms facilities. The kit includes a barrier which protects the user from germs and bacteria that may be lurking on toilet seats. The kit further includes a carrying container, sterilization wipes and hand sanitizer to ensure that the user remains clean before and after using the facilities.

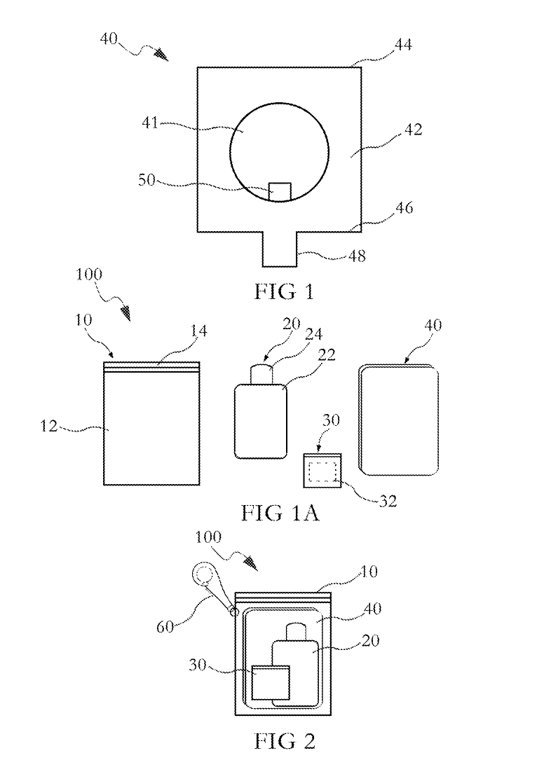

Turning now descriptively to the drawings, referring to FIG. 1, a perspective view of a portable toilet sanitation kit 100 is shown in accordance with an exemplary embodiment of the present invention. The portable toilet sanitation kit 100 includes a carrying container 10. The container 10 is comprised of a body 12 and a closure 14. The body 12 may be a bag or box that is sealed shut along the closure 14. The closure 14 may be a resealable zipper lock or a snap lock. This way the body 12 may be opened and sealed repeatedly by a user. Additionally, with a soft body 12 the user is able to store the container 10 in a bag, purse, suitcase, vehicle or the like for easy portability and containment.

Within the carrying container 10 may be a plurality of items. First, may be a receptacle of sanitizing solution 20 comprised of a receptacle 22 and a dispenser 24. The receptacle 22 may be a bottle, packet, vial or canister. The dispenser 24 may be a spout, a manual squirt top or spray top, an aerosol spray or the like. The receptacle 22 houses a sanitizing solution or antibacterial liquid that the user may rub on their hands to kill germs and bacteria on their skin. Along with the receptacle of sanitizing solution 20 one or more packets 30 with a sanitizing wipe 32 may be included in the carrying container 10. The wipe 32 may be used to wipe the toilet seat, handle and surrounding areas before using the toilet. The wipes 32 may be used on the hands as a convenient alternative to the liquid sanitizer in the receptacle 22 for the user.

The carrying container 10 may further include a toilet seat cover 40. The toilet seat cover 40 serves as a barrier or protective layer between the user's body and the toilet seat. As illustrated in FIG. 1(A) the toilet seat cover 40 comprises a perimeter sheet 42 with a central opening 41. The perimeter sheet 42 may be squared or circular shaped, and may be made from a thin, flexible plastic or rubber material to enable repeated uses and cleanings The perimeter sheet 42 is positioned atop the toilet seat with a back portion 44 aligned against a toilet tank and a front portion 46 aligned against the front of the toilet bowl. The opening 41 rests over the toilet bowl. At the front portion 46 of the perimeter sheet 42 is an outer flap 48 that hangs outside the toilet bowl. The outer flap 48 is positioned on the outer edge of the perimeter sheet 42 at the front portion 46 to protect the user's garments and undergarments from coming into contact with the toilet and from getting splashed or soiled while seated. An additional inner flap 50 is attached to the front portion 46 hanging within the opening 41. This inner flap 50 prevents water, urine and residue from splashing out of the toilet bowl.

Referring now to FIG. 2, a perspective view of the portable toilet sanitation kit 100 is shown in accordance with an exemplary embodiment of the present invention. All of the items are enclosed within the carrying container 10. The toilet seat cover 40 may fold or roll to fit within the container 10 along with the receptacle of sanitizing solution 20 and the packet of wipes 30. This way the user is able to easily transport the items so that they are readily available when a public restroom is presented. The carrying container 10 may include an attachment means 60 fasten the container 10 to an object like a bag, suitcase, stroller, or cart. The attachment means 50 may be a spring clip, a carabineer, a hook, hook clip, or the like to releasably secure the kit 100 to the object while still providing easy access when desired.

To use the portable toilet sanitation kit 100 the user first wipes the toilet seat and surrounding areas where the user may touch with a sanitizing wipe 32. The wipes 32 are disposable to enable discard within the toilet. Next the user positions the toilet seat cover 40 over the toilet seat with the back portion against the tank and the front portion at the front edge of the toilet bowl. The flaps 48 and 50 are positioned with the outer flap 48 in front of the toilet bowl, and the inner flap 50 within the bowl at the front end. The seat may be given time to dry before placing the cover 40. After using the toilet the user may dispense the sanitation liquid onto their hands to disinfect them. The liquid may also be used prior to toilet use. Finally, the cover 40 is wiped again before folding and placing it back into the carrying container 10. By utilizing the portable toilet sanitation kit 100 the user is afforded peace of mind that their restroom experience is clean and safe.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A portable toilet sanitation kit comprising:
a. a carrying container to house a plurality of items, where the carrying container includes a closure;
b. at least one packet with a sanitizing wipe, where the packet is carried within the carrying container; and
c. a toilet seat cover folded within the carrying container, where the toilet seat cover includes:
i. a perimeter sheet with a central opening, where the perimeter sheet rests atop a toilet seat, and where the perimeter sheet extends between a back portion and a front portion; and
ii. an outer flap hanging at an outer edge of the perimeter sheet at the front portion of the toilet seat.

2. The portable toilet sanitation kit according to claim 1, where the carrying container further includes a receptacle of sanitizing solution.

3. The portable toilet sanitation kit according to claim 1, where the carrying container is a bag with a zipper lock closure.

4. The portable toilet sanitation kit according to claim 1, where the carrying container is a box with a snap lock closure.

5. The portable toilet sanitation kit according to claim 1, where the carrying container includes an attachment means, where the attachment means fastens the carrying container to an object.

6. The portable toilet sanitation kit according to claim 5, where the attachment means is one of at least a hook clip, a carabineer, a spring clip or hook.

7. The portable toilet sanitation kit according to claim 1, where the toilet seat cover made from a reusable material to enable repeated use and cleaning of the toilet seat cover.

8. The portable toilet sanitation kit according to claim 1, where the toilet seat cover includes an inner flap attached within the opening at the front portion of the perimeter sheet.

9. A method of use for a portable toilet sanitation kit for use with a toilet comprising the steps of:
a. removing a sanitizing wipe and a reusable toilet seat cover from a carrying container;
b. wiping a toilet seat with the sanitizing wipe;
c. placing the reusable toilet seat cover on a toilet seat;
d. using the toilet;
e. wiping the toilet seat cover with an additional sanitizing wipe; and
f. replacing the reusable toilet seat cover in the carrying case.

10. The method of use for the portable toilet sanitation kit according to claim 9 further comprising the step of sterilizing a user's hands with a sanitation solution withdrawn from the carrying container.

11. The method of use for the portable toilet sanitation kit according to claim 9 further comprising the step of unclipping the carrying container from an object before use.

12. The method of use for the portable toilet sanitation kit according to claim 9 further comprising the step of allowing the toilet seat to dry after wiping with the sanitizing wipe.

13. The method of use for the portable toilet sanitation kit according to claim 9 further comprising the steps of:
a. wiping the toilet seat cover with another sanitizing wipe; and
b. placing the toilet seat cover back into the carrying case.
